(19) United States
(12) Patent Application Publication
(10) Pub. No.: US 2020/0174156 A1
(43) Pub. Date: Jun. 4, 2020

(54) BLOCKAGE DETECTION & WEATHER DETECTION SYSTEM WITH LIDAR SENSOR

(71) Applicant: Continental Automotive Systems, Inc., Auburn Hills, MI (US)

(72) Inventor: Nehemia Terefe, Santa Barbara, MI (US)

(73) Assignee: Continental Automotive Systems, Inc., Auburn Hills, MI (US)

(21) Appl. No.: 16/204,816

(22) Filed: Nov. 29, 2018

(51) Int. Cl. G01V 8/20; G03B 17/18; G01C 3/08; G02B 27/00; G01S 7/497; G01S 17/93

(52) U.S. Cl. CPC G01V 8/20; G03B 17/18; G01C 3/08; G01S 2007/4977; G01S 7/497; G01S 17/936; G02B 27/0006

(57) ABSTRACT

A method and apparatus detects foreign material on a window of a LIDAR sensor and determines existence of a bad weather condition (fog, spray, rain). The LIDAR sensor has an illumination portion including a light source; a receiving portion having at least one photodetector for receiving light, sent from the light source, that is reflected from an object in a field of view of receiving optics; a blockage detection portion adjacent to the illumination portion; and a window portion extending from the illumination portion to the blockage detection portion. The method prevents light, from the light source that is scattered when foreign material is on a surface of the window or when a bad weather condition exists, to pass into the receiving portion and permits such scattered light to pass into the blockage detection portion. The scattered light is collected on a photodiode disposed in the blockage detection portion.

### FIELD

This invention relates to advanced driver assist systems or autonomous driving vehicles using LIDAR (Light Detection and Ranging), camera and, in particular, to a system using a High Resolution Flash LIDAR (HFL) sensor that detects when the field of view is blocked by foreign material causing performance degradation.

### BACKGROUND

LIDAR sensors like camera, radar and other ADAS sensors suffer from significant performance degradation when the field of view of the sensor is blocked by any foreign material, i.e., when dirt or other foreign materials deposit on the window of the sensor through which it views the environment. In the particular case of an HFL sensor, the impact of blockage will be significant as the sensor is mounted outside of the car where it is directly affected by the environment making it susceptible to blockage. These blockage materials and structures on the window include, but are not limited to, water drops, snow, salt, ice, condensation, splash, spray, dirt, mud, dust, fouling, stickers, shatter, scratch etc.

In the case of blockage, the performance of the HFL sensor degrades due to the following main reasons. First, the power of the laser light source is partially or fully blocked reducing the maximum detectable distance. Secondly, the blocking materials degrade the quality of the image or point cloud by decreasing the resolution, contrast, sharpness and range accuracy. In addition, the blocking materials hinder the view of part of or all of the field of view. Finally, most blocking materials create a halo around objects creating false returns around objects.

As shown in FIG. 1, a conventional HFL sensor 10 has an illumination portion (I) including a laser 11 and a receiving portion (R) including a lens 12 and a detector array 14 for receiving reflected light. The detector array 14 includes a plurality of pixels (not shown) arranged on a focal plane array (FPA). For protection of the lenses and diffusors from damage in hostile environments and for aesthetic purposes, usually a transparent glass window 18 is disposed in front of the driver assistant sensors mounted in exterior of the vehicle. With such a design, the transmitter and receiver share a common glass and since there is no partition through the window 18 of the sensor 10, if a blockage such as a raindrop, mud, dirt, scratch etc. 20 is on a window 18, some part of the light LL from the laser 11 is guided through the window 18 and gets picked up by the receiving portion R. This is an unwanted effect for the normal functioning of the sensor 10. Physically, this leakage signal arises when light L reflected or scattered on the glass window 18 is guided through the window 18 and coupled to the lens 12 due to further reflection or scattering on the glass window 18.

Normally this light leakage introduces a negligible signal on the receiving portion R if the window 18 is very clean. However, in cases where there are some particles or materials 20 the surface of the window 18, the amount of leakage signal significantly increases blinding the sensor 10 for close distances. The foreign materials on the glass window 18 increase the guided light through the window 18 by increasing the reflection or scattering of laser light L between the glass and blockage interface.

To address the above issues, another conventional HFL sensor 10′, shown in FIG. 2, ensures that the partition 16′ separates the window 18 into two window portions 18, 18′ to prevent any kind of direct leakage of light L from illumination portion I to the receiving portion R. The lens 12 thus only receives light RL that is reflected from an object (not shown) being sensed. Alternatively, the partition 16′ can pass through a common window 18.

However, neither sensors 10 nor 10′ can detect the blockage or foreign materials on the window 18 reliably without impairing the normal functionality (object sensing) of the sensor.

Thus, there is a need to detect the blockage or foreign materials on a window of a LIDAR sensor at all times to help take appropriate measures in event of such blockage.

### SUMMARY

An objective of the invention is to fulfill the need referred to above. In accordance with the principles of an embodiment, this objective is achieved by a LIDAR sensor having an illumination portion including a light source. A receiving portion is adjacent to the illumination portion. The receiving portion has receiver optics and at least one photodetector for receiving light, sent from the light source that is reflected from an object in a field of view of the receiver optics. A first partition separates the illumination portion from the receiving portion so that light from the light source cannot enter the receiving portion due to the first partition. A blockage detection portion of the sensor is adjacent to the illumination portion. A second partition separates the illumination portion from the blockage detection portion. A first window portion extends from the receiving portion to the illumination portion, and a second window portion extends from the illumination portion to the blockage detection portion. The first partition separates the first window portion from the second window portion to prevent light from the light source from entering the receiving portion via the window portions, with the reflected light being able to pass through the window to the photodetector or array of photodetectors. The second partition permits light, from the illumination portion that is scattered when foreign material is on a surface of the window, to pass into the blockage detection portion. The blockage detection portion includes a photodiode and structure defining that is constructed and arranged to allow the scattered light to pass through the aperture and collect on the on a photodiode.

In accordance with another aspect of an embodiment, a method for detecting foreign material on a window of a LIDAR sensor and of detecting a bad weather condition in an environment is provided. The LIDAR sensor has an illumination portion including a light source; a receiving portion adjacent to the illumination portion having a photodetector for receiving light, sent from the light source, that is reflected from an object in a field of view of the photodetector; a blockage detection portion adjacent to the illumination portion; and a window portion extending from the illumination portion to the blockage detection portion. The method prevents light, from the light source that is scattered when foreign material is on a surface of the window or when a bad weather condition is present, to pass into the receiving portion. Light, from the light source that is scattered when foreign material is on a surface of the window or when the bad weather condition is present, is permitted to pass into the blockage detection portion. The scattered light is collected on at least one photodiode disposed in the blockage detection portion.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a schematic view of a conventional HFL sensor having a common window for both illumination and receiving portions allowing light leaking from an illumination portion of the sensor to enter a receiving portion of the sensor.

FIG. 2 is a schematic view of another conventional HFL sensor having a partition separating a window to prevent light leaking from an illumination portion of the sensor to enter a receiving portion of the sensor.

FIG. 3 is a schematic view of a HLF system including an HFL sensor with a dedicated blockage detection channel and a control unit, provided in accordance with an embodiment.

FIG. 4 is a schematic drawing of an integrated circuit of the HLF sensor of FIG. 3.

FIGS. 5A and 5B show different configurations of a pinhole aperture and photodiode arrangements of further embodiments of HFL sensors of the system.

FIG. 6 is a schematic view of the sensor of FIG. 33 shown detecting a bad weather condition.

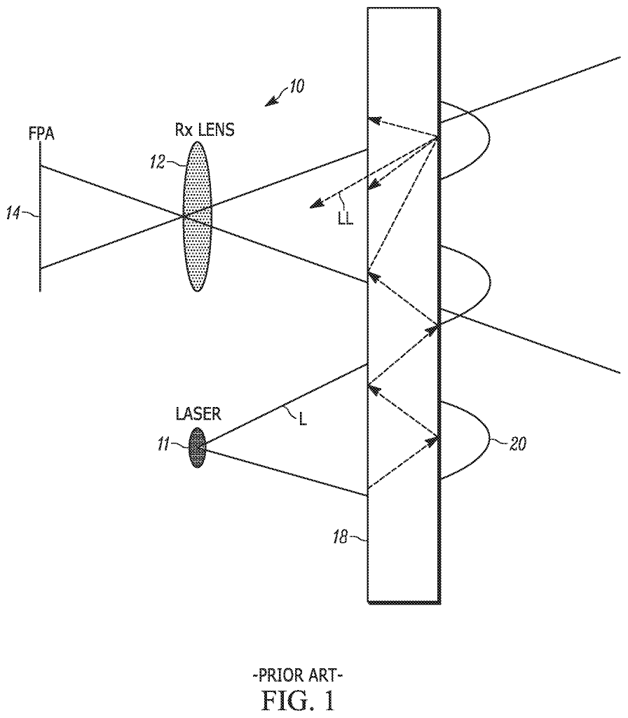

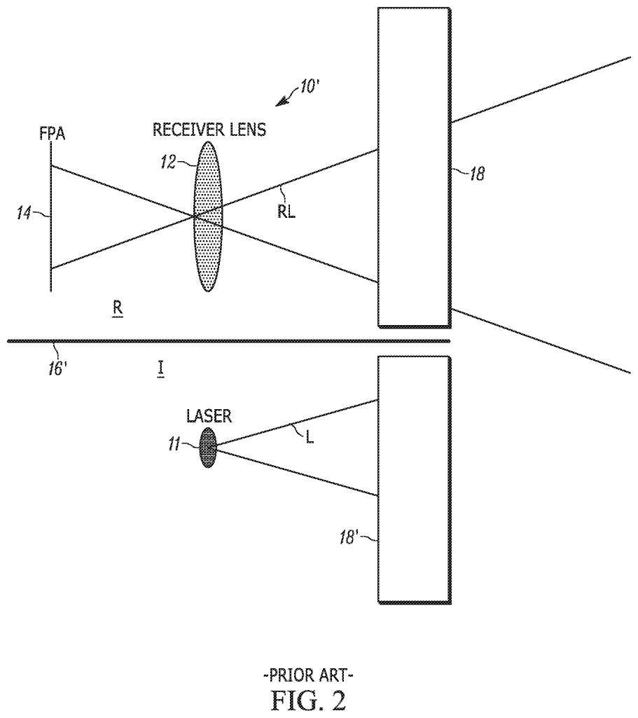

### DETAILED DESCRIPTION OF EXEMPLARY EMBODIMENTS

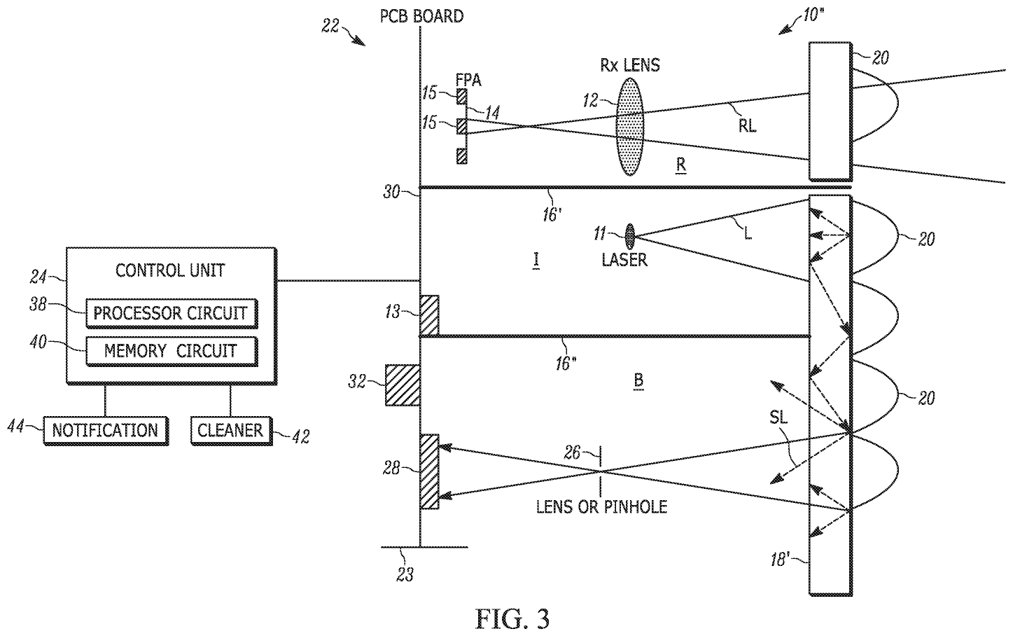

With reference to FIG. 3, a LIDAR system is shown, generally indicated at 22, in accordance with an embodiment. The system 22 is preferably for use in a driver assist system of a vehicle (not shown) or for autonomous driving vehicle. The system 22 includes a LIDAR sensor 10″, preferably, a High Resolution Flash LIDAR (HFL) sensor. The sensor 10″ is typically mounted on a surface 23 of the vehicle so that the window portions 18, 18′ thereof is outside of the vehicle and exposed to the environment. The sensor 10″ illuminates an area outside of the vehicle with laser light and detects the reflection of the laser light from objects disposed in the lighted area. A control unit 24 is electrically coupled to the sensor 10″ so as to process signals received from the sensor 10″.

The HFL sensor 10″ has an activation illumination portion (I) including a laser 11 and a flash detector 13, and a receiving portion (R) including receiver optics such as a lens 12 and a photodetector such as a PIN photodiode or a detector array 14 for receiving reflected light RL. In the embodiment of FIG. 3 a detector array 14 is provided including a plurality of pixels 15 arranged on a focal plane array (FPA). A partition 16′ separates the illumination portion I from the receiving portion R. The partition 16′ also extends through the window 18 to prevent any kind of direct leakage of light L from illumination portion I to the receiving portion R.

In accordance with the embodiment, a blockage detection portion B is provided adjacent to the illumination portion I. The window portion 18′ extends from the illumination portion I to the blockage detection portion. As shown in FIG. 3, due to the complete partition 16′ between window portions 18 and 18′, there is a full separation (isolation) between the receiving portion R and the illumination portion I. However, the illumination portion I and the blockage detection portion B do not have a full separation (isolation) and thus they share the same window due to the partition 16″ not extending through the window portion 18′. This structure does not have any detrimental impact on the normal functioning of the HFL sensor 10″ since there is still a full separation between the receiving portion R and the illumination portion I. However, the illumination portion I and blockage detection portion B share the common window portion 18′ to enable the detection of laser light blockage due to foreign material disposed on the surface of the window portion 18′.

Within the blockage detection portion B, there structure such as a lens or a member defining a pinhole aperture 26, that is constructed and arranged to allow leaked or scattered laser light SL to collect on one or more photodiodes 28. The photodiode 28 is mounted on a printed circuit board 30 of the sensor 10″ and converts the collected scattered laser light SL to electrical current.

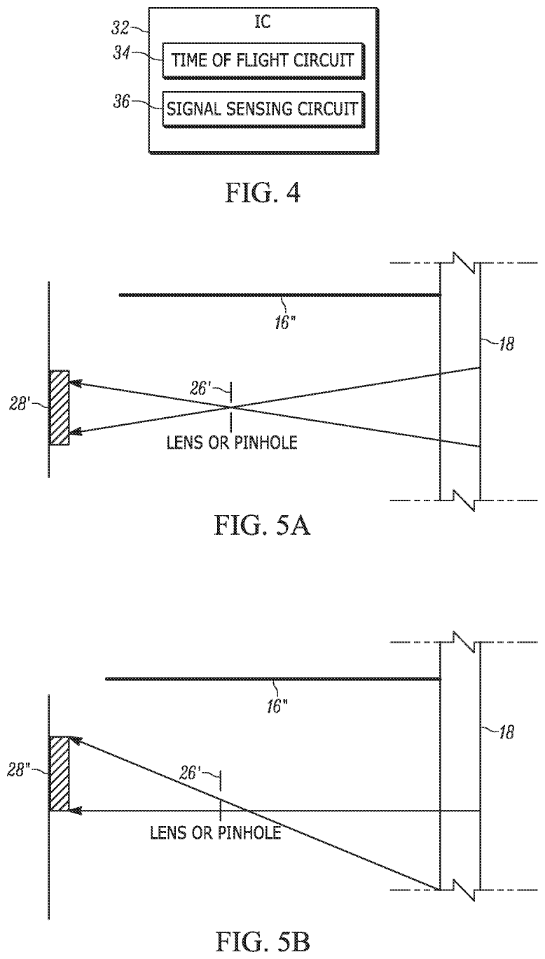

The photodiode 28 is connected with an integrated circuit (IC) 32 that is mounted on the circuit board 30. With reference to FIG. 4, the IC 32 includes a time of flight measuring circuit 34 that is constructed and arranged to sample the electric current from the photodiode 28 at regular time intervals and to keep track of the time it takes for the light pulse (e.g., from SL) to propagate from the laser 11 to the photodiode 28. The IC 32 also includes a signal processing circuit 36 that is constructed and arranged to compute the amplitude and distance of the light pulse received by the photodiode 28 and to determine the existence and non-existence of blockage from foreign material 20 on the window 18. Instead of providing the IC 32 in the sensor 10″, the IC 32 can be provided in the control unit 24.

Thus, as shown in FIG. 3, the laser light SL scattered off from the blockage material 20 makes its way through the lens or the pinhole aperture 26 and arrives at the photodiode 28. The photodiode 28 is connected with IC 32 which computes the amplitude of the signal at the given time interval and forwards this signal to a processor circuit 38 of the control unit 24. The processor circuit 38 calculates distance and amplitude. From the computed distance and amplitude, blockage detection algorithm of software executed by the processor circuit 38 determines whether or not there is a blockage on the window 18. The main criteria for detecting the extent or existence of blockage on the window 18 is the detection of high amplitude zero meter or a very close pulse detected by the photodiode 28. This blockage detection method also takes advantage of the point clouds generated by the HFL sensor 10″ for final decision.

The main blockage detection criteria is the reception of a signal on blockage photodiode 28 whose distance is very close (<50 cm). Reception of a signal on the photodiode 28 alone does not guarantee a detection of blockage as light from a far object could be sensed by the blockage photodiode 28. However, the sensing capability of the blockage photodiode 28 is significantly reduced for far objects with the use of the pinhole 26 instead of a lens. This is why a pinhole is used as a preferred embodiment to reduce the ambiguity of the blockage detection. In addition, existence and non-existence of object in the main receiving channel of the LIDAR sensor can also be used as an input for blockage detection. Absence of an object in the main receiving channel and existence of a very close range signal on the blockage detection channel leads to high reliability of blockage detection. Moreover, amplitude of the signal on the blockage photodiode 28 and kinematics of the vehicle will be further used to qualify existence of blockage.

It can be appreciated that the functions of the control unit 24 can be integrated into the sensor 10″ by providing the processor circuit 38 and memory circuit 40 on the circuit board 30.

With reference to FIGS. 5A and 5B, it is possible to vary the arrangement of the pinhole aperture 26′ relative to the photodiode detector 28. As seen in FIG. 5A, a shorter distance from the photodetector 28′ to the pinhole aperture 26′ ensures that the photodiode 28′ views a much larger field of view. This increases the signal collected but requires a significant amount of room on the window 18, which in turn increases the space required.

In the embodiment of FIG. 3, the distance between the pinhole aperture 26 to photodiode 28 is greater than that shown FIG. 5A. This spacing helps to reduce the space required on the window 18, but this spacing reduces the field of view and reduces the amount of received light from blockage making it less sensitive.

FIG. 5B shows that it is also possible to offset the center of the photodiode 28″ relative to the center of the pinhole aperture 26′ to allow the photodiode 28″ to look only in a desired direction. This configuration is very useful if one wants the photodiode 28″ to detect only blockage. Normally, the photodiode could also detect other objects, but blockage is located at zero meter or at least very close distance. This is a preferred configuration for HFL sensor 10″. This configuration enables the blockage detection to work even when a vehicle is at standstill.

When a blockage of light is detected by the sensor 10″ such to exceed a predetermined threshold, the control unit 24 or processor circuit 38 thereof can generate a signal to activate a cleaner 42 (FIG. 3), such as a wiper, a washer, air pump or a heater, to remove the blockage on the window 18. If the blockage still persists after cleaning or heating of the window 18, the sensor 10″ can transition into low performance mode and notify, with a notification signal 44, the driver to remove blockage or go to service.

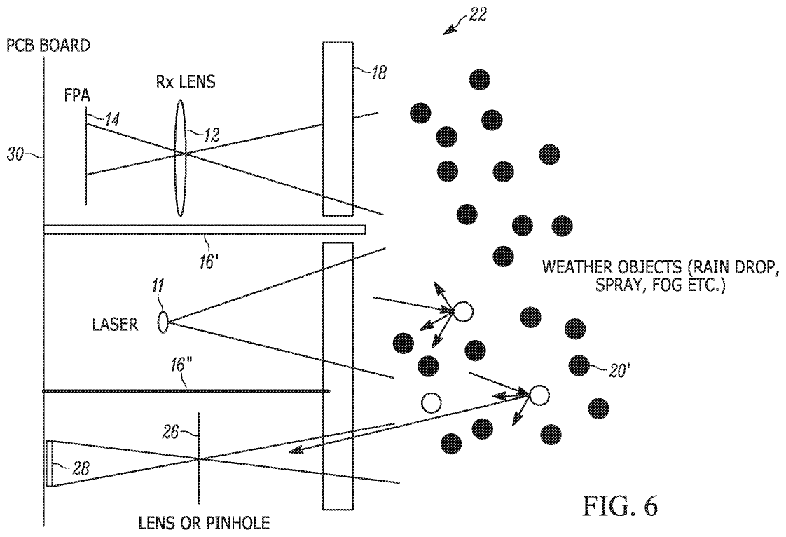

The system 22 can be used to detect bad weather. With reference to FIG. 6, the signal from the photodiode 28 can be used as an input to determine existence and non-existence of bad weather 20′ such as rain, snowfall, drizzle, fog, spray, water splash, hail, smoke, steam, sandstorm, and dust from a dust storm in the surrounding environment. When bad weather is detected, the integrated circuit 32 or processor circuit 38 is constructed and arranged to generate a signal to operate a windscreen wiper of a vehicle in an attempt to automate wiper activation.

Advantages of the system 22 of the embodiment include:
effectively detects non-transparent and transparent blockages, such as water drops, ice, fine dust, a scratch, etc.
doesn't need additional light source
doesn't need a dedicated measurement cycle
saves space
is very sensitive (can even pick up small amount of blockage)
   It helps for weather detection of weather (rain, spray, fog etc.) reliably
uses only few components
can easily be integrated to the HFL sensor infrastructure
is a very cost-effective solution
responds quickly to onset and removal of blockage
requires significantly short algorithm runtime for detection
It can distinguish object from blockage reliably
It can distinguish weather object (spray, rain, fog) from blockage
Takes advantage of the image captured by the LIDAR sensor.
helps to determine density of blockage easily
enables self-cleaning and heating of the LIDAR sensor

The operations and algorithms described herein can be implemented as executable code within a the IC 32 or control unit 24 having processor circuit 38 as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a micro-processor circuit (not shown) and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 40 can be implemented, for example, using a non-volatile memory such as a programmable read only memory (PROM) or an EPROM, and/or a volatile memory such as a DRAM, etc.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A LIDAR sensor comprising:
an illumination portion including a light source,
a receiving portion adjacent to the illumination portion, the receiving portion having receiver optics and at least one photodetector for receiving light, sent from the light source, that is reflected from an object in a field of view of the receiver optics,
a first partition separating the illumination portion from the receiving portion so that light from the light source cannot enter the receiving portion due to the first partition,
a blockage detection portion adjacent to the illumination portion,
a second partition separating the illumination portion from the blockage detection portion, and
a first window portion extending from the receiving portion to the illumination portion,
a second window portion extending from the illumination portion to the blockage detection portion, the first partition separating the first window portion from the second window portion to prevent light from the light source from entering the receiving portion via the window portions, with the reflected light being able to pass through the window to the photodetector or array of photodetectors,
wherein the second partition permits light, from the illumination portion that is scattered when on foreign material is on a surface of the window, to pass into the blockage detection portion, and
wherein the blockage detection portion includes at least one photodiode and structure that is constructed and arranged to allow the scattered light to pass through the aperture and collect on the at least one photodiode.

2. The sensor of claim 1, further comprising an integrated circuit associated with the photodiode, the integrated circuit comprising a time of flight measuring circuit constructed and arranged to sample electric current from the photodiode at regular time intervals and to keep track of the time it takes for the light pulse to propagate from the light source to the photodiode.

3. The sensor of claim 2, wherein the integrated circuit further comprises a signal processing circuit constructed and arranged to compute an amplitude and distance of a light pulse received by the photodiode and to determine an existence or non-existence of foreign material on the surface of the window and to determine the existence and non-existence of bad weather.

4. The sensor of claim 3, wherein the foreign material is one of water drops, snow, salt, ice, condensation, splash, spray, dirt, mud, dust, a sticker, shatter, and a scratch in the window.

5. The sensor of claim 3, wherein the bad weather is one of rain, snowfall, drizzle, fog, spray, water splash, hail, smoke, steam, sandstorm, and dust.

6. The sensor of claim 1, wherein the sensor is a high-resolution flash LIDAR sensor or any other LIDAR sensor.

7. The sensor of claim 1, wherein the photodetector is a detector array comprising a plurality of pixels on a focal plane array.

8. The sensor of claim 1, wherein the light source is a laser.

9. The sensor of claim 1, further comprising a flash detector in the illumination portion.

10. The sensor of claim 1, wherein the structure is a member having an aperture.

11. The sensor of claim 1, further comprising a processor circuit electrically coupled with the sensor and constructed and arranged to process signals obtained from the sensor.

12. The sensor of claim 11, mounted on a surface of a vehicle such that the window portions are outside of the vehicle.

13. The sensor of claim 12, further comprising a cleaner such that when foreign material is detected on the window, the processor circuit is constructed and arranged to generate a signal to operate the cleaner in an attempt to remove the foreign material from the window.

14. The sensor of claim 3, wherein when bad weather is detected, the integrated circuit is constructed and arranged to generate a signal to operate a windscreen wiper of a vehicle in an attempt to automate wiper activation.

15. The sensor of claim 12, wherein the cleaner is a wiper, a heater, air pump or a washer.

16. A method of detecting foreign material on a window of a LIDAR sensor and of detecting a bad weather condition in an environment, the method comprising:
providing a LIDAR sensor having an illumination portion including a light source; a receiving portion adjacent to the illumination portion having receiver optics and at least one photodetector for receiving light, sent from the light source, that is reflected from an object in a field of view of the receiver optics; a blockage detection portion adjacent to the illumination portion; and a window portion extending from the illumination portion to the blockage detection portion,
preventing light, from the light source that is scattered when foreign material is on a surface of the window or when a bad weather condition is present, to pass into the receiving portion,
permitting light, from the light source that is scattered when foreign material is on a surface of the window or when the bad weather condition is present, to pass into the blockage detection portion, and
collecting the scattered light on a photodiode disposed in the blockage detection portion.

17. The method of claim 16, further comprising:
determining, from the collected scattered light, an extent of light blockage caused by the foreign material on the surface of the window.

18. The method of claim 16, further comprising:
determining from the collected scattered light and collected objects from the field of view of the receiving portion, whether the collected scattered light is caused by the foreign material on the window, a bad weather condition or an outside object.

19. The method of claim 18, wherein the determining step includes computing an amplitude and distance of a light pulse received by the photodiode.

20. The method of claim 16, wherein the sensor is provided as a high-resolution flash LIDAR sensor or any other LIDAR sensor.

21. The method of claim 16, wherein the foreign material is one of water drops, snow, salt, ice, condensation, splash, spray, dirt, mud, dust, a sticker, shatter, and a scratch in the window.

22. The method of claim 16, wherein the bad weather condition is one of rain, snowfall, drizzle, fog, spray, water splash, hail, smoke, steam, sandstorm, and dust.

23. The method of claim 17, when the blockage of light exceeds a predetermined threshold, the method further comprises:
operating a cleaner in an attempt to remove the foreign material from the window, or
sending a notification regarding the blockage.

24. The method of claim 18, wherein when a bad weather condition is detected, the method further comprises:
generating a signal to operate a windscreen wiper of a vehicle in an attempt to automate wiper activation.
